(19) United States
(12) Patent Application Publication
(10) Pub. No.: US 2004/0233057 A1
(43) Pub. Date: Nov. 25, 2004

(54) Programmable magnetic data tag

(76) Inventors: Colin S. Sills, Impington (GB); Timothy S. Norris, Saffron Waldon (GB)

Correspondence Address: NIXON & VANDERHYE, PC, 1100 N GLEBE ROAD, 8TH FLOOR, ARLINGTON, VA, 22201-4714, US

(21) Appl. No.: 10/486,161

(22) PCT Filed: Aug. 6, 2002
(86) PCT No.: PCT/GB02/03618

(30) Foreign Application Priority Data
Aug. 6, 2001 (GB) 0119185.7

(51) Int. Cl. G08B 13/14

(52) U.S. Cl. 340/572.6; 235/493

(57) ABSTRACT

There is described a programmable tag susceptible to magnetic interrogation using an interrogating magnetic field, the tag comprising: (a) a plurality of saturable magnetic structures (310) for non-linearly coupling the interrogating magnetic field into a corresponding response magnetic field; (b) reversibly programmable magnetic regions (330) for applying offset magnetic fields to the magnetic structures for modifying their non-linear coupling characteristics. The tag is susceptible to being mass-produced from a continuous strand of tag material severed to produce individual tags. The tag is of advantage in that it can be reversibly programmed. There is also described a method of recording data on the tag, the method including the steps of: (c) bringing the tag in close proximity to a recording apparatus; and (d) applying a magnetising magnetic field to each of the magnetic regions (330) for modifying a magnetic field retained therein to which its associated saturable structure is subjected.

### FIELD OF THE INVENTION

The present invention relates to a programmable tag; in particular, but not exclusively, the invention relates to a programmable tag which is magnetically readable using low frequency magnetic fields, the tag bearing information magnetically thereon. The invention further relates to a method of writing data onto the programmable tag.

### BACKGROUND TO THE INVENTION

Magnetically readable tags and readers capable of interrogating such tags are known from a first published international PCT patent application no. PCT/GB99/00081. Each tag comprises a plurality of magnetic layers, each layer having associated therewith a corresponding easy axis in which it is most easily magnetised. Data is stored on each of the tags by the relative orientations of its easy axes. Moreover, the readers are capable of determining the magnetic coercivities and orientations of the easy axes of the layers. Furthermore, by employing advanced interrogating coil configurations and appropriate signal processing in the readers, it is also possible to determine the spatial positions of the layers as well as their orientations and coercivities, thereby enable multiple tags to be interrogated simultaneously and their associated data read.

The layers can, if required, be substituted with magnetic wire structures which have more precisely defined magnetic orientations.

The tags described in the foregoing are of advantage in that they are robust and can be manufactured inexpensively. Moreover, they are difficult to copy and are hence susceptible to providing verification to documents of value, for example high value bills of exchange and banknotes. Moreover, they can be embedded into manufactured items for providing anti-counterfeiting measures or anti-theft measures.

A preferred method of fabricating the magnetic tags is to assembly together layer sheets of magnetic material in mutually different relative orientations to impart data thereto and thereby form a stack of layers. Tags are then punched in large numbers from the stack, the tags all bearing an identical data code. The layer sheets can be fabricated from polyethylene teraphthalate (PET), polyvinyl chloride (PVC), polypropylene or paper onto which is sputter deposited a thin magnetic coating. The coating is preferably substantially 0.9 μm thick. A manufacturer IST based in Zulte, Belgium manufactures such sheet layers with associated magnetic coating, the layers marketed under a trade name Atalante and having a product reference number SPR97017A. When magnetically interrogated, the easy axis of the layers exhibits coercivity which is overcome at about 5 A/m.

However, unlike radio frequency identification (RFID) tags incorporating electronically programmable silicon integrated circuits including random access memory for data storage, the magnetic tags are capable of offering only limited reprogrammability. For example, in a second published international PCT patent application no. PCT/US00/19935, there is described a method of recording data on a magnetic data tag, the tag comprising a plurality of magnetic elements. The method involves negating magnetic characteristics of the tag by destructive processes such as thermal exposure, removing all or a portion of a coating of one or more of the elements, and breaking or fracturing one or more of the elements. Such thermal exposure may be executed, for example, by heating the elements using pulsed laser radiation or by Joule heating using high frequency inductive coupling. Such negation can be employed to switch irreversibly one or more of the elements from an equivalent logic ‘1’ state to an equivalent logic ‘0’ state.

In the second PCT application, it will be appreciated that the method of programming described therein is only capable of recording data by a non-reversible process which renders the tag rather akin to a fusible read only memory (ROM). The inventors of the present invention have appreciated that it is desirable to be able to record data on a magnetic data tag and subsequently reversibly change the data. Such a re-programmable characteristic is advantageous where magnetic tags are employed to individually identify products on a production line and for recording processing steps to which the products have already been subjected to in the course of their manufacture, especially if the products are returned to an earlier process step for reworking or correction.

Thus, the present invention is directed at addressing the problem of providing a magnetic tag which is capable of being reversibly reprogrammed a potentially large number of times.

### SUMMARY OF THE INVENTION

According to a first aspect of the present invention, there is provided a programmable tag susceptible to magnetic interrogation using an interrogating magnetic field, the tag comprising:

(a) a plurality of saturable magnetic structures for non-linearly coupling the interrogating magnetic field into a corresponding response magnetic field;

(b) reversibly programmable magnetic biasing means for applying offset magnetic fields to the magnetic structures for modifying their non-linear coupling characteristics.

The tag is of advantage in that the tag is capable of being reprogrammed a potentially large number of times.

Preferably, the biasing means is fabricated from one or more of the following material systems: ferrous oxide, chromium dioxide and Arnakrome. Such material systems are capable of retaining magnetic fields therein and therefore applying a field offset to their corresponding structures for modifying their magnetic coupling characteristics.

Preferably, the biasing means comprises a magnetically recordable region, such that one or more of the structures has associated therewith one or more corresponding regions. Thus, it is of advantage to provide each saturable structure with a corresponding recordable region so that saturable structure is capable of yielding recorded data when interrogated.

Preferably, the magnetically recordable regions are disposed substantially parallel to their corresponding saturable magnetic structures. Such a disposition ensures that each structure is capable of being subjected to a substantially constant magnetic offset field from its corresponding region.

Preferably, the region has a thickness in a range of 10 μm to 100 μm. More preferably, the region has a thickness of substantially 30 μm.

Conveniently, saturable magnetic structures are implemented as one or more of thin magnetic films and magnetically saturable wires. Both magnetic films and magnetically saturable wires are capable of being manufactured in large quantities at relatively low cost.

Preferably, the structures are elongate and disposed mutually parallel to one another; such parallel disposition eases manufacturing when the tag is severed from a continuous tag strand. Alternatively, the structures are elongate and disposed in mutually different angular orientations; such mutually different orientations assists with reliability of tag interrogation when discerning coercivity values. More preferably, therefore, the structures are disposed in a substantially radial configuration.

Preferably, to render the tag robust, the tag further comprises a substrate backing layer. More preferably, the substrate is fabricated from one or more of: PVC, PET, paper, card or polypropylene.

Preferably, for recording a useful amount of data on the tag whilst not rendering the tag too costly to manufacture or too bulky, the tag incorporating in a range of two to fifty magnetically saturable structures. More preferably, the tag incorporating in a range of three to twelve magnetically saturable structures.

In order to render the tag inexpensive to manufacture, the tag is preferably manufacturable from a continuous strand of tag material severed to produce individual tags.

In a second aspect of the present invention, there is provided a method of manufacturing a tag according to the first aspect of the invention, the method including the steps of:

(a) providing the magnetically saturable structures, the biasing means and one or more substrate layers in the form of elongate ribbons or wires;

(b) abutting the ribbons or wires in appropriate configuration in a tool;

(c) affixing the ribbons or wires together to form a continuous strand; and

(d) severing the strand to generate one or more of the tags.

In a third aspect of the present invention, there is provided a method of recording data on a tag according to the first aspect of the invention, the method using a data recording apparatus, the method including the steps of:

(a) bringing the tag in close proximity to the recording apparatus; and

(b) applying a magnetising magnetic field from the apparatus to the biasing means for modifying a magnetic field retained therein to which its associated saturable structure is subjected.

Preferably, a high frequency magnetic bias is applied to improve accuracy of the magnetic field retained in the biasing means.

### DESCRIPTION OF THE DIAGRAMS

Embodiments of the invention will now be described, by way of example only, with reference to the following diagrams in which:

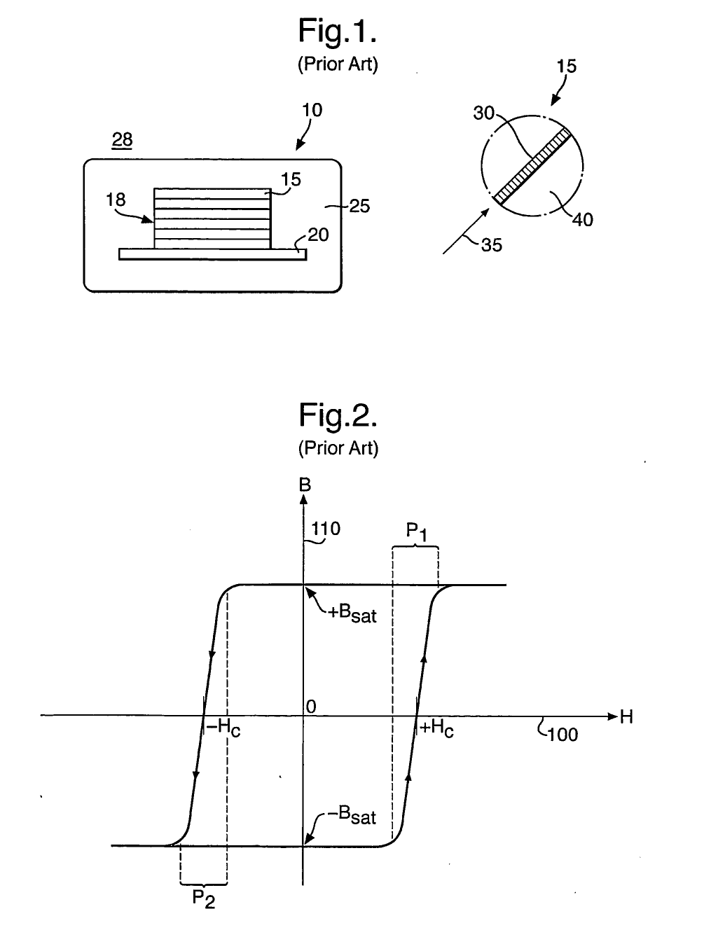

FIG. 1 is a schematic diagram of a magnetic tag comprising a plurality of layers, each layer including a magnetic wire whose coercivity and orientation can be measured;

FIG. 2 is a graph illustrating B-H magnetising characteristics of a layer of the tag in FIG. 1;

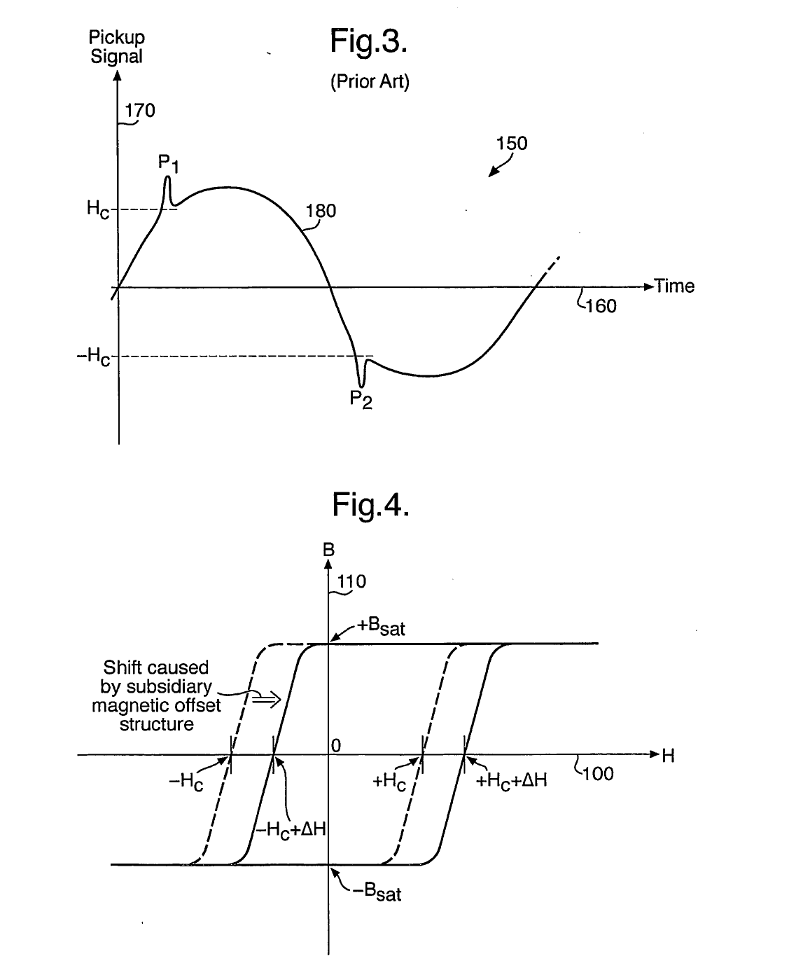

FIG. 3 is a diagram of a magnetic pickup signal received from the layer as a result of the characteristics in FIG. 2;

FIG. 4 is a graph of modified B-H magnetising characteristics of the layer resulting from the inclusion of a subsidiary magnetic offset structure therewith;

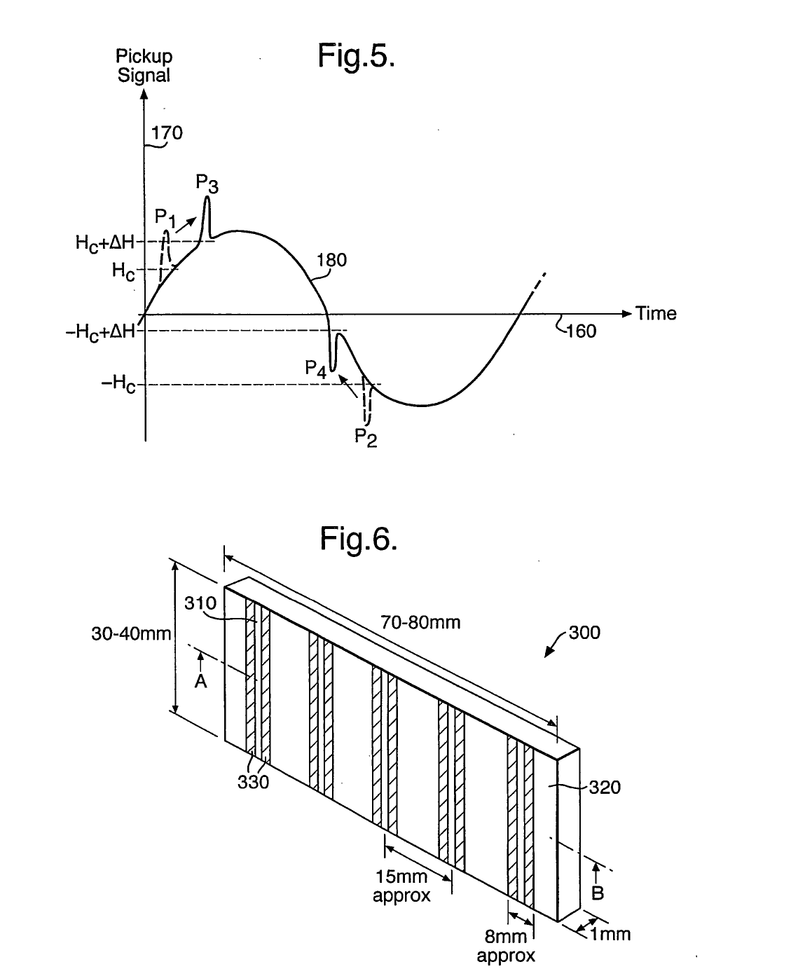

FIG. 5 is a diagram illustrating a magnetic signal received from the layer affected by its associated magnetic offset structure;

FIG. 6 is an illustration of a tag according to the invention comprising a plurality of magnetic wire structures and magnetisable strips associated therewith;

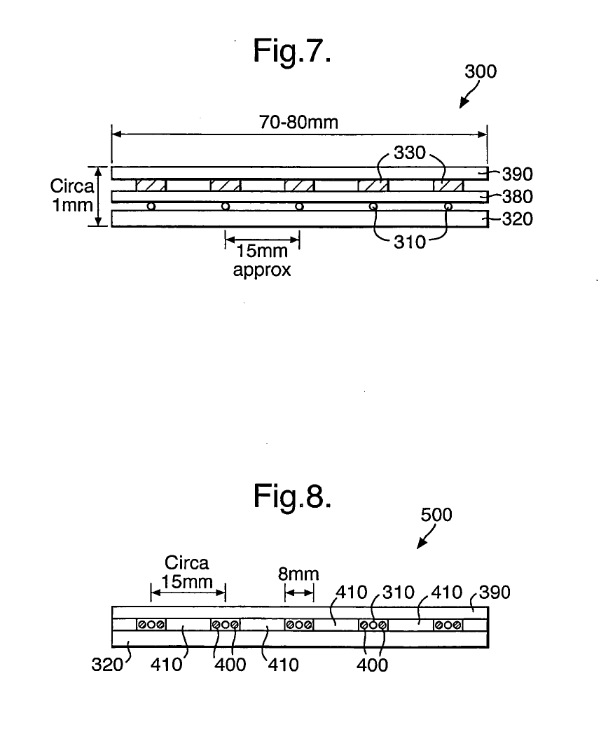

FIG. 7 is a cross-sectional view through an axis A-B of the tag illustrated in FIG. 6;

FIG. 8 is a cross-section view of an alternative tag according to the invention, the alternative tag including magnetic wire-like elements and associated wire-like magnetisable structures;

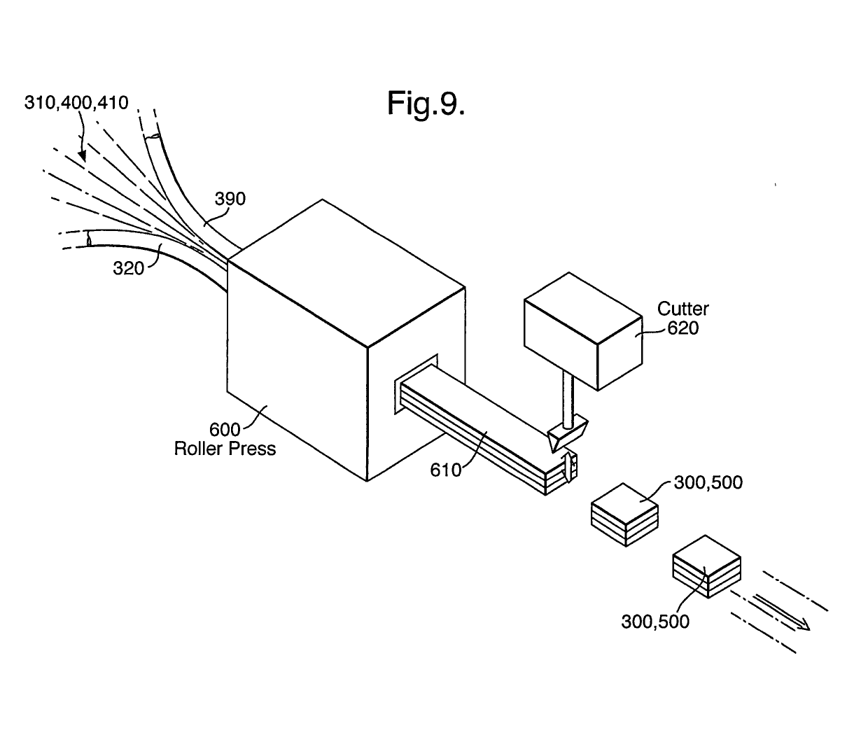

FIG. 9 is an illustration of a method of manufacturing programmable tags according to the invention; and

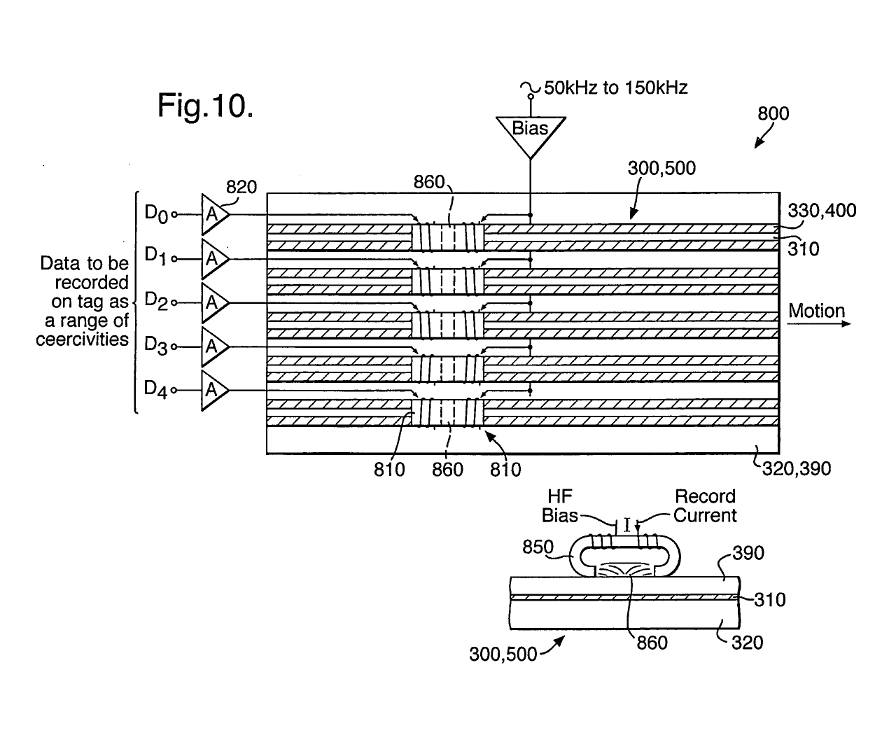

FIG. 10 is a schematic illustration of recording apparatus for recording data onto the tag illustrated in FIGS. 1 to 8.

### DESCRIPTION OF EMBODIMENTS OF THE INVENTION

Referring now to FIG. 1, there is shown a magnetic data tag indicated generally by 10. The tag 10 comprises a plurality of layers, for example a layer 15, assembled together to form a stack 18. The stack 18 is in turn attached to a hard magnetic backing layer 20. Finally, the stack 18 and its associated backing layer 20 are encapsulated in a resin shell 25 which protects the stack 18 and the backing layer 20 from their surrounding environment 28.

The layers of the stack 18 each include a magnetic strip 30 formed onto a non-magnetic plastics material backing layer 40. The strip 30 has an easy axis magnetic orientation as indicated by an arrow 35. The plastics backing layer 40 is preferably fabricated from polyethylene teraphthalate (PET), polyvinyl chloride (PVC), polypropylene or paper onto which is sputter deposited a thin magnetic coating. The layers of the stack 18 are assembled in different relative orientations to impart data to the tag 10.

The magnetic strip 30 is formed from a magnetic coating which is preferably substantially 0.9 μm thick. The layers with their associated magnetic coatings are fabricated by a manufacturer IST based in Zulte, Belgium, the layers marketed under a trade name Atalante and having a product reference number SPR97017A. When magnetically interrogated, the easy axis of the layers exhibits coercivity which is overcome at about 5 A/m. The tag 15 is known in the art.

Referring now to FIG. 2, there is shown a graph illustrating B-H magnetising characteristics of a layer of the tag in FIG. 1. The graph has magnetising force H plotted along an abscissa axis 100 and resulting magnetic flux density B plotted along an ordinate axis. The layer exhibits a magnetic hysteresis characteristic where a certain magnetising force H_{c} is required to switch magnetic state of the layer. When the magnetising force is further increased, the magnetic flux density B within the strip 30 saturates at a level Bₛₐₜ. Thus, the layer illustrates a non-linear characteristic whereby a rapid transition of the magnetic flux density B around H_{c} gives rise to high frequency magnetic fields that can be sensed using appropriate magnetic pickup coil assemblies.

Thus, when a layer of the tag 15 is interrogated using a steered magnetic interrogating field having a magnetising force greater than H_{c} and swept cyclically to align with the easy axis 35 of the layer, a pickup signal as illustrated in FIG. 3 can be obtained from a pickup coil assembly held in relatively close proximity, namely in the order a ten's of cm, to the tag 10.

Referring now to FIG. 3, the pickup signal is shown plotted on a graph indicated generally by 150. The graph 150 includes an abscissa axis 160 for representing time, and an ordinate axis 170 for representing the pickup signal. A generally sinusoidal signal representing the interrogating magnetic field is denoted by 180. Moreover, there are two peaks P1 and P2 corresponding to abrupt changes of the magnetic field B in the tag 10 as illustrated in FIG. 2. From a measure of the steering direction of the interrogating magnetic field and the times at which the peaks P1, P2, occur, it is possible to determine the orientation of the easy axis 35 of the layer and also its coercivity H_{c}.

When performing signal processing of the pickup signal depicted in FIG. 3, high frequency filtration can be applied to remove the interrogating field component. Moreover, the pickup coils can be configured to be relative insensitive to the interrogating field, whose source is relatively remote, and selectively sensitive to non-linear magnetic field components generated in the tag 10 in close proximity to the coils.

The aforesaid second international PCT application no. PCT/US00/19935 is concerned with recording data on magnetic tags by negating their magnetic characteristics. Such negation involves changing irreversibly the level of H_{c} necessary to cause saturation in tag structures or layers, and/or changing irreversibly Bₛₐₜ that such layers or structures are capably of sustaining. Such negation has the effect of symmetrically altering the magnetic characteristics illustrated in FIG. 2.

The inventors have appreciated that such negation represents a severe limitation on the ability of magnetic data tags to be individually coded and be subsequently modified to bear new data. Thus, the inventors have appreciated that it is preferable to offset the magnetic characteristic in a manner as depicted in FIG. 4.

Referring now to FIG. 4, there is illustrated a modified B-H magnetising characteristic for a reprogrammable magnetic tag according to the invention, the re-programmable tag including strips 35 as for the tag 10 but in a modified configuration where the strips 35 have associated therewith corresponding subsidiary magnetic offset structures. It will be appreciated from FIG. 4 that the magnetic characteristic has been shifted along the abscissa axis 100 so that it is no longer symmetrical about a central origin O. The presence of the subsidiary magnetic structure does not cause magnetic negation of the strip 35. Moreover, the subsidiary structure is not itself in any way negated.

The presence of the subsidiary structure causes temporal shifting of the peaks P1, P2 in FIG. 3 to be modified to corresponding peaks P3, P4 respectively as depicted in FIG. 5. The peak P1 is shifted to occur at a relatively greater interrogating magnetic field strength of H_{c} +ΔH, whereas the peak P2 is shifted to occur at a relatively lesser interrogating magnetic field strength of −H_{c} +ΔH. It will be appreciated from FIG. 5 that the occurrence of the peaks P3, P4 can be measured using a configuration of pickup coils and data processing applied to pickup signals generated by the coils, for example a simultaneous equation solve. The data processing is capable of not only determining the angular orientation of the layer giving rise to the characteristic in FIG. 5 but also determining values for H_{c} and ΔH. Thus, the layer itself is capable of providing a mechanism by which the magnetic characteristics of the subsidiary structure can be determined. By arranging for the subsidiary structure to be reversibly permanently magnetised, data can be written to the tag according to the invention and changed potentially almost a limitless number of times.

Preferably, the subsidiary structure is fabricated from ferrous oxide in a similar manner to magnetic recording tape as employed in earlier reel-to-reel magnetic tape recorders and more contemporary magnetic cassette recorders.

Referring to FIG. 6, there is shown a tag according to the invention indicated generally by 300. The tag 300 comprises a plurality of substantially parallel magnetic structures, for example a structure 310, each capable of exhibiting a magnetic characteristic as illustrated in FIG. 2; the structures are preferably each of strip-like form similar to the strip 30 in FIG. 1. The tag 300 further comprises a non-magnetic stable substrate 320, the substrate 320 being preferably fabricated from PVC, PET, paper, card or polypropylene. Associated with the strips are corresponding magnetically recordable regions, for example the structure 310 has a recordable region 330 associated therewith. The regions are preferably fabricated from ferrous oxide, chromium dioxide, “Arnakrone” alloy or a mixture of any of these materials. The regions preferably are preferably in a range of 10 μm to 100 μm thick, more preferably substantially 30 μm thick.

The tag 300 is preferably in a range of 70 to 80 mm wide, in a range of 30 to 40 mm long, and substantially 1 mm thick. Moreover, the structures are preferably spaced apart at a distance of substantially 15 mm between their centres. Moreover, the regions associated with the structures are preferably each substantially 8 mm wide as illustrated.

It will be appreciated that the tag 300 can be made smaller if required. However, best performance is obtained for the tag 300 having dimensions as described above and illustrated in FIG. 6.

FIG. 7 is a cross-sectional view of the tag 300 of FIG. 6 along an axis A-B. The tag 300 includes, in series, the substrate 320, the strips 310, a plastics material or paper spacer layer 380, the magnetically recordable regions 330 and finally a passivating layer 390. The passivating layer 390 can be one or more of a lacquer layer, an adhesive layer, an overprinted label layer and a clear or coloured plastic passivation layer.

It will be appreciated that the strips 310 in the tag 300 can be substituted by magnetically soft saturable wire if required, the wire exhibiting similar characteristics to the strips 310.

Referring now to FIG. 8, there is shown an alternative form of construction for the tag 300, the alternative tag indicated generally by 500. The tag 500 comprises the substrate 320, the strips 310 implemented in the form of magnetically saturable wires, magnetically recordable wires 400 on adjacent sides of the magnetically saturable wires, and the passivating layers 390. Each strip 310 has associated therewith two wires 400, the wires 400 performing a similar function to the regions 330. Preferably, spacer elements 410 are included between each set of wires 310, 400 although these are not essential because the passivating layer 390, if required, through the action of applied heat can be fused to the substrate 320 during manufacture.

The tags 300, 500 can be modified so that their strips are disposed in mutually different relative angular orientations. For example, the strips can be arranged in a radial manner. Such an angular disposition of the strips can improve tag readability.

The tags 300, 500 are preferably manufactured as a continuous strand and then cut to form individual tags in a manufacturing process is depicted in FIG. 9. In FIG. 9, the substrate 320 as a continuous ribbon, the passivating layer 390 as a continuous ribbon, the wires 310, 400 and the spacer elements 410 as continuous ribbons are conveyed to a roller press 600 which combines the substrate 320, the layer 390, the wires 310, 400 and the elements 410 under heat and pressure to form a continuous tag strand 610 which is then subsequently severed by a cutter 620 at regular intervals to generate individual tags 300, 500.

Once severed, the tags 300, 500 can be individually programmed to suit their final applications, for example in retailing and in anti-counterfeiting measures. If required, the strand 610 can have labels printed thereon so that labeling and tagging of products can be achieved simultaneously when the tags 300, 500 are affixed thereto.

Recording of data on the tags 300, 500 is achieved in a similar manner to recording onto magnetic tape. For best recording, a magnetising field applied to record data on the strips 310 and regions 330 or wire 400, the magnetising field comprises a magnetising field component and high-frequency bias field component. Preferably, the bias field component is at a frequency in a range of 50 kHz to 150 kHz.

Referring to FIG. 10, there is shown a recording apparatus indicated generally by 800, The apparatus 800 incorporates a linear array of recording coils, for example a coil 810. Each recording coil is driven by an associated current amplifier, for example an amplifier 820. Each amplifier is provided with a corresponding data level D, for example the amplifier 820 is supplied with a recording level DO. Moreover, each coil is provided with an high frequency bias signal as described in the foregoing.

Each coil comprises a magnetic ferrite core 850 and an associated air gap region 860 across which fringing fields are developed which, when the coil is held in close proximity or contact with the strip 310, are capable of preferentially and reversibly magnetising the region 330 or wires 400 associated with the strip 310.

The tags 300, 500 are drawn past the coils 810 so that coils remain aligned with the strips 310 and their regions 330 or wires 400 to record the data DO to D5 thereonto.

The bias is capable of improving recording accuracy onto the tags 300, 500 and thereby defining their element coercivity values more accurately, thereby render the tags 300, 500 capable of recording more data by virtue of the degree of magnetisation of the strips.

If required, the recording apparatus can be applied to the strand 610 shown in FIG. 9 for recording a standard code thereonto prior to the cutter 620 severing the strand 610 to generate individual tags 300, 500. The tags 300, 500 can therefore be manufactured preprogrammed with data thereon.

Although the tags 300, 500 are illustrated as including five strips or wires 310, they can each include in a range of two to fifty such strips or wires. More preferably, the tags 300, 500 include in a range of three to twelve such strips or wires.

The tags 300, 500 can be made smaller than illustrated in the diagrams where application demand that the tags should be more compact.

It will be appreciated that alterations and modifications can be made to embodiments of the invention described in the foregoing without departing from the scope of the invention. Features of the embodiments described can be combined in any combination without departing from the scope of the invention.

1. A programmable tag susceptible to magnetic interrogation using an interrogating magnetic field, the tag comprising:
(a) a plurality of saturable magnetic structures for non-linearly coupling the interrogating magnetic field into a corresponding response magnetic field;
(b) reversibly programmable magnetic biasing means for applying offset magnetic fields to the magnetic structures for modifying their non-linear coupling characteristics.

2. A tag according to claim 1, wherein the biasing means is fabricated from one or more of the following material systems: ferrous oxide, chromium dioxide and Arnakrome.

3. A tag according to claim 1, wherein the biasing means comprises a magnetically recordable region, such that one or more of the structures has associated therewith one or more corresponding regions.

4. A tag according to claim 3, wherein the magnetically recordable regions are disposed substantially parallel to their corresponding saturable magnetic structures.

5. A tag according to claim 3, wherein the region has a thickness in a range of 10 μm to 100 μm.

6. A tag according to claim 5, wherein the region has a thickness of substantially 30 μm.

7. A tag according to saturable magnetic structures are implemented as one or more of thin magnetic films and magnetically saturable wires.

8. A tag according to any claim 1, wherein the structures are elongate and disposed mutually parallel to one another.

9. A tag according to claim 1 wherein the structures are elongate and disposed in mutually different angular orientations.

10. A tag according to claim 9, wherein the structures are disposed in a substantially radial configuration.

11. A tag according to claim 1, further comprising a substrate backing layer.

12. A tag according to claim 11, wherein the substrate is fabricated from one or more of: PVC, PET, paper, card or polypropylene.

13. A tag according to claim 1, the tag incorporating in a range of two to fifty magnetically saturable structures.

14. A tag according to claim 13, the tag incorporating in a range of three to twelve magnetically saturable structures.

15. A tag according to claim 1 manufactured from a continuous strand of tag material severed to produce individual tags.

16. A method of manufacturing a tag according to claim 1, the method including the steps of:
(a) providing the magnetically saturable structures, the biasing means and one or more substrate layers in the form of elongate ribbons or wires;
(b) abutting the ribbons or wires in appropriate configuration in a tool;
(c) affixing the ribbons or wires together to form a continuous strand; and
(d) severing the strand to generate one or more of the tags.

17. A method of recording data on a tag according to claim 1 using a data recording apparatus, the method including the steps of:
(a) bringing the tag in close proximity to the recording apparatus; and
(b) applying a magnetising magnetic field from the apparatus to the biasing means for modifying a magnetic field retained therein to which its associated saturable structure is subjected.

18. A method according to claim 17, wherein a high frequency magnetic bias is applied to improve accuracy of the magnetic field retained in the biasing means.

19. A reprogrammable magnetic data tag substantially as herein before described and/or illustrated in one of more of FIGS. 4 to 10.
